(19) United States
(12) Patent Application Publication
(10) Pub. No.: US 2016/0140589 A1
(43) Pub. Date: May 19, 2016

(54) RETAIL CUSTOMER ENGAGEMENT ZONES

(71) Applicant: International Business Machines Corporation, Armonk, NY (US)

(72) Inventors: Ajay Ashok Deshpande, Yorktown Heights, NY (US); Kimberly D. Hendrix, Yorktown Heights, NY (US); Herbert Scott McFaddin, Yorktown Heights, NY (US); Chandrasekhar Narayanaswami, Yorktown Heights, NY (US)

(21) Appl. No.: 14/542,232

(22) Filed: Nov. 14, 2014

(51) Int. Cl. G06Q 30/02

(52) U.S. Cl. CPC G06Q 30/0205; G06Q 30/0201

(57) ABSTRACT

A method and system that receives, as input data in a processor of a computer, an identification and location of a retail entity. Map data relevant for the retail entity is received and the retail entity is located on the map data. Data identifying at least one of a product, a product set, and a service or services is received as input data. A listing is received of one or more competitors that offer the product or one or more products of the product set or the service as a competitor of the retail entity for the product, product set or service. The one or more competitors are located on the map data. An affinity for consumers is calculated for the product, product set, or service for the retail entity and each of the one or more competitors.

### BACKGROUND OF THE INVENTION

1. Field of the Invention

The present invention generally relates to analysis of competition among merchants. More specifically, spatiotemporal effects are generated and analyzed relative to competition among merchants for the business of individual customers and customer groups, using contextual data, and spatiotemporal areas referred to herein as “combat zones” or “retail customer engagement zones” are calculated and displayed, and updated as new contextual data is received, from which marketing, merchandising, and/or operations strategies can be dynamically developed or from which existing strategies can be dynamically adjusted.

2. Description of the Related Art

Retailer success has long hinged on a retail organization's ability to understand their customers so well that they can anticipate what those customers will want to buy next and then profitably meet the market demand for those wants and needs better than their competitors.

Traditionally, retailers make use of the limited information about their customers, such as past transaction history, demographic data, and crow-flight distances of their homes to the store and the competitors, to segment their customers into broad groups of similar customers and to establish their trading zone areas. This information is primarily static in nature, and conventional methods are primarily static. Moreover, conventional methods lack the granularity of focusing on individual customers.

### SUMMARY OF THE INVENTION

The present inventors have recognized that recent Internet and mobile technologies potentially provide an immense amount of data that can provide a basis for dynamic calculations as related to retailer competition for consumers' business. The present inventors have also recognized that such data, when filtered if necessary, to be associated with individual customers at specific retail store locations, can serve as contextual data that enriches marketing data for that retail store location and that can even be used to dynamically target specific customers who routinely shop at that retail store location.

Thus, an exemplary objective of this invention is to provide a system and method for retailers to increase their market share and customer loyalty by effectively using analytics in conjunction with contextual information to understand spatiotemporal zones of competition among merchants for retaining or inducing the business of individual shoppers or of groups of shoppers and to discover new opportunities to personalize incentives for shoppers to choose their store over that of a competitor for a given shopping trip, to better plan merchandising and pricing strategies, and to optimize store operations.

In a first exemplary aspect of the present invention, to achieve the above features and objects, described herein is a method including: receiving, as input data in a processor of a computer, an identification and a location of a retail entity; retrieving map data relevant for the retail entity and locating the retail entity on the map data; receiving, as input data, data identifying at least one of a product, a product set, and a service or services; retrieving a listing of one or more competitors that offer the product or one or more products of the product set or the service(s) as a competitor of the retail entity for the product, product set or service(s) and locating the one or more competitors on the map data; and calculating an affinity for consumers for the product, product set, or service(s) for the retail entity and each of the one or more competitors.

In a second exemplary aspect of the invention, also described herein is a method including: receiving, as input data into a processor, an identification of a customer; retrieving map data for a retail entity in a location of the customer and locating the retail entity on the map data; retrieving a history of previous location traces for the customer, the location traces including an indication of a date and a time; determining at least one recurring travel route of the customer, based on the location traces; and superimposing the at least one recurring travel route of the customer on the map data.

In a third exemplary aspect, also described herein is a system including: at least one database storing information for a retail entity, including information on customers, products, product sets, and service(s) offered by the retail entity, information on competitors, and contextual information relating to a store location and customers making purchases at the store location, the contextual information comprising at least one of: information reflecting conditions or events that influence retail purchases at the store location; and information of a personal nature associated with the customers making purchases at the store location and that provides a profile of personal aspects that influence retail purchases at the store location; at least one input section to receive data from multiple data sources providing the contextual information; and at least one processor configured to filter the data from the multiple data sources and to associate it with the store location or the customers and to store it in the at least one database, to retrieve data from the database, to analyze the retrieved data, and to generate and transmit a marketing action to a customer determined to be in an engagement zone with one of the competitors.

These features and capabilities of the present invention may allow retailers to increase their market share and customer loyalty by effectively using contextual analytics to dynamically understand spatiotemporal areas of competition among merchants for the business of individual shoppers or groups of shoppers and to dynamically discover new opportunities to personalize incentives for shoppers to choose their store or brand over that of a competitor.

### BRIEF DESCRIPTION OF THE DRAWINGS

The foregoing and other purposes, aspects and advantages will be better understood from the following detailed description of exemplary embodiments of the invention with reference to the drawings, in which:

FIG. 1 provides an exemplary scenario 100 of how contextual data can be used as a marketing tool for a retail store;

FIG. 2 illustrates a flowchart of an exemplary system 200 for computing and using a combat zone system, according to an exemplary embodiment of the present invention;

FIG. 3 illustrates a flowchart 300 that summarizes the calculation of combat zones;

FIG. 4 illustrates a first exemplary example of a combat zone 400 based on the commute routes, according to an exemplary embodiment of the present invention;

FIG. 5 illustrates a second exemplary example of a combat zone 500, according to an exemplary embodiment of the present invention;

FIG. 6 illustrates an exemplary method 600 of the decision process to offer a marketing promotion using a combat zone, according to an exemplary embodiment of the present invention;

FIG. 7 provides an exemplary flowchart 700 for generating an engagement zone;

FIG. 8 provides an exemplary flowchart 800 of processing by the recommendation engine 226;

FIG. 9 provides an exemplary flowchart 900 of processing by the retailer execution system 230;

FIG. 10 illustrates an exemplary method 1000 of developing shopper profiles used for some methods of combat zone generation;

FIG. 11 illustrates an exemplary architecture 1100 that could be used to implement the present invention;

FIG. 12 depicts a computer system 1200, such as a cloud computing node, according to an embodiment of the present invention;

FIG. 13 depicts a cloud computing environment 1300 according to an embodiment of the present invention; and

FIG. 14 depicts abstraction model layers 1400 according to an embodiment of the present invention.

### DETAILED DESCRIPTION OF EXEMPLARY EMBODIMENTS OF THE INVENTION

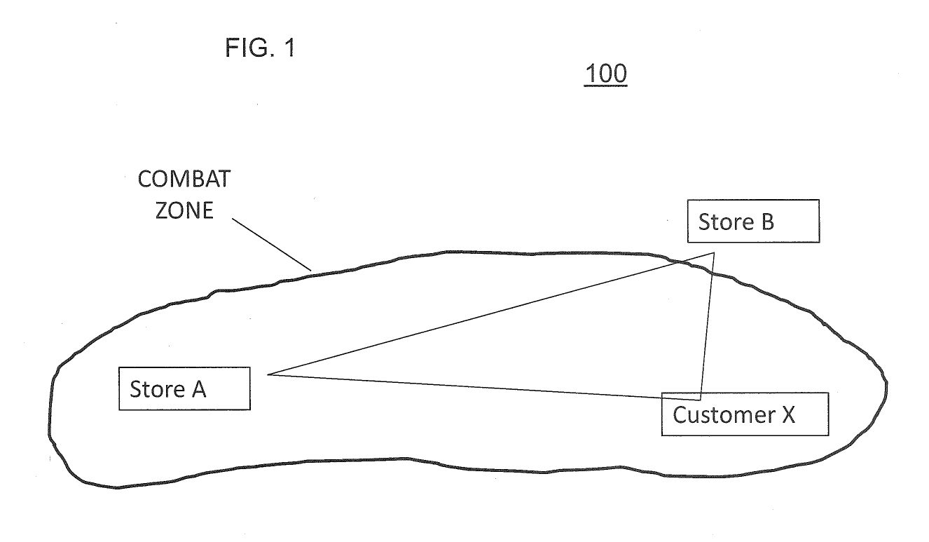

Referring now to the drawings, and more particularly to FIGS. 1-14, exemplary embodiments are shown of the method and structures according to the present invention.

As a preliminary matter, although the present invention is described herein as directed to retail entities providing access to products or product sets, it applies equally to services, including services possibly provided by such retail entities. Because the present invention can be based upon providing services as well as products/product sets, it should be viewed as also directed to entities who provide only service or services. Accordingly, Applicants intend that the engagement zones described herein have a more generic environment than that of retail entities.

The present inventors have recognized that retailers today can potentially benefit from an influx of new data about their customers as made possible by the recent rapid adoption of Internet and mobile technologies. Examples of such new data sources include customer location traces, customer social media contents, geospatial and temporal phenomena such as weather, traffic, and local events, as well as information on competitor presence and actions, including those related to product offerings, pricing, advertising, promotions, and sales as well as other operational or physical/structural elements related to store design, real estate, store staffing, etc.

This input data can incorporate purely spatiotemporal aspects such as the geographic locations and durations, and time of visit and activity carried out at customers' dwell points, store locations, roadways and other structures, as well as the conditions of those roadways and structures. Other examples include weather patterns and predictions, as well as other factors that potentially influence the shopping behavior of the customer or customers, such as the types of products desired by the customer, their demographic characteristics, and other shopping influences. Another example includes information about the product sets and product features offered by the merchants, including competitor merchants, as well as additional promotional data about the merchants and products, such as receiving information that merchant A is running a special whereas merchant B may not be running a corresponding special.

For example, in one specific exemplary implementation of the present invention, one or more hypothetical travel paths of a customer or group of customers (such as drive-to-work, drive-from-work, drive-to-grocery, drive-to-school, etc.) are determined, as well as dwell points (such as home and work locations or frequent shopping venues), through data input with respect to time. Stores along those travel paths or in proximity to the dwell points are then identified, and the likelihood of the customer visiting one or more of the stores for buying an item in a given item category or having a given set of features is calculated. The likelihood information can then be aggregated into spatiotemporal areas herein referred to as “combat zones” or “engagement zones”, such as shown exemplarily in FIG. 1, as indicating zones that a retailer might wish to engage specific marketing events in an attempt to persuade the customer to visit the retailer's store rather than a competitor's store.

As demonstrated by the scenario 100 of FIG. 1, retail store A has used the present invention to calculate a combat zone relative to customer X and relative to retail store B, who competes with retail store A in a specific product or product set. By monitoring contextual data relative to customer X, including possibly updating the combat zone if appropriate, store A can determine whether it might be useful to take marketing action to attempt to persuade/entice customer X to shop at store A rather than competitor store B.

This example demonstrates that such new data, if harnessed, could provide a better understanding by retailers of the dynamic context of their customers, including each customer specifically, if desired. Such dynamic data updates could provide greater insight into customers' shopping behavior not only for a given retailer's store, but across stores, geographies, dates, times, and conditions, resulting in an ability to analyze an expanded set of factors that influence shopping behavior and build market share.

As related to the present invention, the term “affinity” refers to a calculated measure of likelihood that a customer will purchase a specific product, an item from a specific product set from a specific retailer, or service, given identified local competing retailers offering the same product or product set or service. “Affinity” also refers to a calculated measure of likelihood that a customer, including, if desired, a specific customer, will visit the specific retailer location within a predetermined time period, which likelihood, in some cases, is calculated based on detecting the customer's current location.

The term “engagement zone” or “combat zone” refers to an area surrounding a retailer that is associated with an affinity value. The term “contextual data” refers to any data additional to data traditionally stored by retail entities for transaction history, which additional data is possibly relevant to whether a consumer will purchase a specific product or item from a product set. Contextual data is typically data that has now become available because of Internet services and/or information from mobile devices commonly used now by consumers.

It is noted that many large retail entities have a Master Data Management (MDM) site, which serves as a data repository for customer purchase data, inventory data, and site location data (locations of different stores of the retail entity). The contextual data inputs into the present invention, therefore, adds much data to this conventional retailer database, that can serve as a rich data source to be mined to provide dynamic, updated modeling for consumer affinities to different competing retailers.

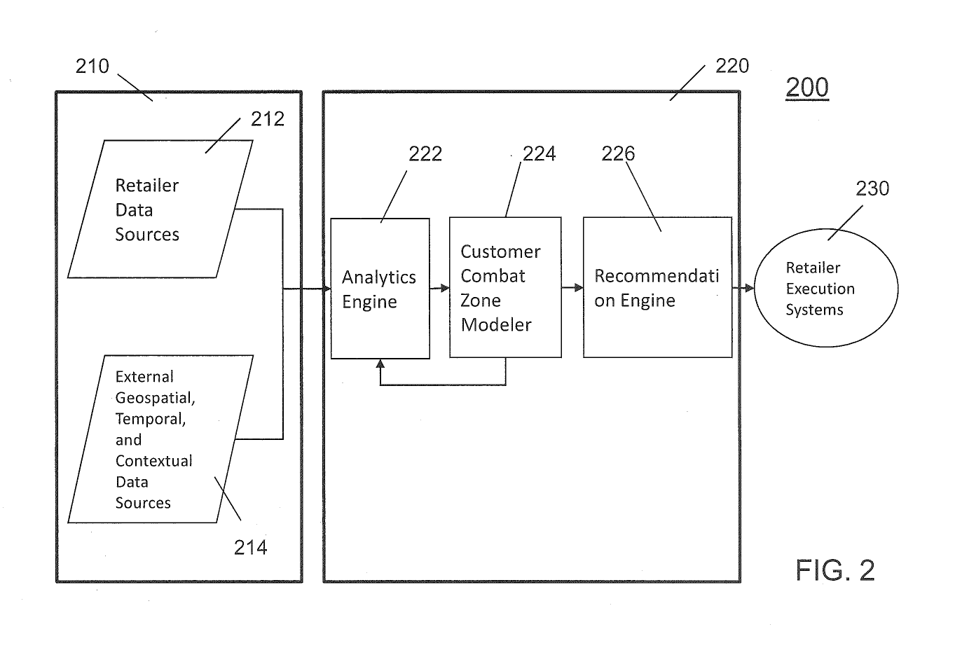

FIG. 2 illustrates a block diagram of an exemplary system 200 for determining and utilizing an engagement zone (combat zone). Retailer data sources 212 and other contextual data sources 214, which form data source 210, are input into an analytics engine 222 of processor 220.

The analytics engine 222 combines the data (for example, combining store locations with highway locations as well as weather effects to achieve a weighted spatiotemporal travel estimate) and mines for attributes and attribute values related to where and when customers shop or travel by time, product category, and/or location. The customer combat zone modeler 224 of the processor 220 then creates shopper combat zone maps (see below) and calculates shopping probabilities and expected value forecasts by location, time period, product category and/or service(s).

The recommendation engine 226 of the processor 220 can then recommend specific marketing activities or other touch points and offers to intercept customers on a timely basis and to provide an incentive to purchase. The retailer execution system 230 executes the recommended marketing activities. While the above system 200 is illustrated as a single data source 210 and processor 220, these systems can be formed of multiple data streams, databases, and processors working either in parallel or in series.

It should also be clear that the analytics engine 222, customer combat zone modeler 224, and recommendation engine 226 can also comprise either a single computer or a plurality of computer systems. The data sources 210 can be entered into the analytics engine 222 from prepared data sets or in real time directly from the data source (e.g., a traffic website). In addition, the retailer execution system 230 can be part of the whole system, or a separate stand alone system (e.g., a customer's promotions system).

In an exemplary embodiment of the invention, the combat zones are determined by combining and analyzing multiple data sources. Examples of the data sources used include retailer data sources such as retail store location, transaction data, market basket data, loyalty card data, shopper check-ins, shopper e-commerce engagement and browser history. Another example of other potential contextual data include customer location traces that can be used to determine customer current location, as well as provide data for determining the shopping path or vicinity of travel by time of day and day of week for each customer, whether by foot or by motor vehicle or by public transport, by mining location traces for recurring travel paths such as between home and work, home and a retail store, home and a point of interest.

Contextual data also includes geospatial and temporal phenomena such as weather, traffic flows and patterns, local events, and competitor locations and actions, including actions related to product offerings, pricing, advertising, promotions, and sales, as well as other operational elements related to, for example, store design, real estate, store staffing, etc. It is noted that much contextual data is currently available via services that broadcast such specialized information on the Internet, sometimes as a subscription service, and that are readily available to the public, including, of course, retailers who have implemented the method of the present invention and receive such data in the format of, for example, RSS data streams.

Some forms of incoming data, such as current location data, requires that it be associated with specific individuals in the retailer's database of customers, and such association can be achieved by, for example, automatic filtering of some type of identification tag included in the incoming current location reporting data. Other incoming data can be associated with specific individuals using an inferencing mechanism such as, for example, associating a specific school lunch menu with a parent whose child is known to attend that school.

Such contextual data is developed from data from various possible sources so that a profile of each individual can be generated, as related to possible purchase models with the retail entity for one or more products or services available from the retail entity, and can updated as more information of that individual becomes known. Different aspects or data of this profile data might be useful for developing different models, depending upon which specific product or product category or service is being modeled. Data for the individual's profile can be entered manually, or it can be automatically entered into appropriate individual profile files or other associative storage techniques as information updates are received through any number of possible electronic data sources, or it can be updated using both manual and automatic update mechanisms. The individual may also provide the profile data in response to emails, text messages, coupon clipping, calendar data, etc., and other forms of possible data that would be expected to evolve in the future.

Non-limiting examples of data sources for automatic updates to the profile stored in the individual profiles might include, for example, mobile apps that permit the individual to interact with the retail entity and RSS (Rich Site Summary) feeds, or equivalents such as Atom syndication format feeds, which use a family of standard web feed formats to publish frequently updated information and which can publish updated information from a website or can aggregate data from many sites. RSS files can be read both by automated processes as well as human users, so that RSS update data can be filtered and distributed as appropriate to individual profile files or for purpose of data mining, using inferencing models, to associate with different profile files. Other examples of automatic data inputs include, for example, a number of apps and techniques which automatically report a current location of a user's mobile device. The present invention intends to include such automatic current location updates as a form of contextual information for that individual.

Association between incoming data and specific individuals can be direct, by reason that the incoming data has a specific individual's name or other identification. Examples of such direct association might include, for example, current location information coming from a user's mobile device, inputs provided by a customer using an app from the retail store, or reports of Internet activity from a customer's browser.

Other incoming data can be associated with one or more individuals indirectly, by reason that relevance can be inferred between the incoming data and specific individuals. For example, incoming traffic congestion reports can be associated with customers having residence or work addresses or commute routes near the congested areas. Another example would be associating school lunch menu information with specific customers having children attending these schools.

In an exemplary embodiment, some of the data streams are integrated and stored as contextual attributes, for example, in a format of data structures. Such data structures may have place holders for identification of individual customers that are associated with the input data. For example, a data structure could be set up that collects time/location traces for a specific individual that can then be retrieved as a unit when analysis is executed or updated for that individual.

The data sources for contextual data can also include, but are not limited to, shopper identification information of any type, whether it be anonymized identification or named identification and/or otherwise identifiable to an individual in any way, shopper location traces captured from mobile applications, location-enabled tracking devices, shipping data, location check-ins, calendar entries, social media posts, purchased travel, or any other manner of location tracking, and shopper demographics, online and in-store browsing and purchase history, social media posts, combat zone-specific government census and micro-economic data, ambient weather conditions, weather history and forecasts for areas located in proximity to shopper location traces, listings of retail stores and service provider located in proximity to shopper location traces, local events and activities located in proximity to shopper location traces, and retail stores and service provider marketing activities such as sales, circulars, media advertising, promotional events and price offers.

This constant monitoring of contextual data relative to consumers of retail services provides a mechanism for dynamically updating the combat zones described herein. For example, if a shopper had previously browsed for lumber on a home improvement retailer's store and is detected as currently passing by a competitor selling that item, the combat zone would be weighted stronger for those particular competitor/time parameters.

Similarly, the retailer's data, or a competitor's data, can be automatically captured and stored. Such data streams include, but are not limited to, product or service offerings, product or service pricing, promotional activities, marketing and advertising activities and events, and customer ratings and reviews over time. Additionally, relevant competitors can be dynamically determined based on the contextual factors such as competitors' location, weather, local traffic, and customer's demographic factors and their past transactions.

For example, during the rush traffic hour, the system 200 might receive traffic data that indicates that the freeway exit and local roads to the nearby competitor or a retailer are clogged and it is unlikely that shoppers visit the competitor during that time. The system 200 takes this traffic congestion into account and adds or subtracts weight to other competitors' influence in calculating the current engagement zones.

In another example, based on a customer's inferred income level from the census data, the system 200 may narrow the set of competitors for specific customers, since consumers can be roughly classified into segments based on income as to which retail stores they predictably will frequent. For example, one income class might prefer Walmart over an exclusive downtown boutique store. As another example, if a customer is known to be shopping for organic groceries, the system 200 will consider only organic friendly grocery stores as main competitors for certain products and focus on their data for the current engagement zones related to grocery shopping for that customer.

It should be clear from these examples, that contextual data can originate from many different data sources and can be associated with specific individual customers or customer groups, the retail store itself and/or its general environment, and to competitor stores. It should also be clear that some forms would require filtering, either express filtering using, for example, identification tags, or implicit filtering using, for example, an inferencing mechanism, in order to be associated with different customer profiles. Other forms of contextual data, such as traffic and weather conditions, would be generically filtered for association with the retails store/competitor locations. It should also be clear that, if the retail entity is a large chain, then the present invention could be used as a tool for comparisons/improvements between different stores within the chain.

The analysis of the information from constant streams of contextual data sources enables the automated creation and assessment of the spatiotemporal areas of competition for the business of the customer, the shopper combat zone. The combat zone is computed by appending shopper profiles with geospatial and temporal attributes derived from analytics techniques applied to myriad public and private data sources to obtain information such as that listed above. In an embodiment of the invention, a function that estimates at a customer's source point (location) the likelihood of the customer visiting any store for buying an item with or without a marketing incentive is used to define combat zones where the customer's likelihood of visiting a store is greater than that for any other store.

The combat zones also can be updated on an ongoing automated basis. These combat zones can be produced in order to establish, for example, time-based views of customer combat zones or product-based view of customer combat zones.

The combat zone can also be used to infer individual customer shopping behavior, such as shopping trip types and trip purchase intentions. This information, in turn, can be used to model customer behavior to predict customer responses to various marketing stimuli. The system can recommend retailer and service provider marketing and merchandising programs that have the highest likelihood of response in the context of the shopper's combat zone. In an exemplary embodiment of the invention, marketing offers, price promotions or targeted messages can be personalized to an individual shopper, a segment of shoppers, or all shoppers in a shopper combat zone based on rules—defined triggers.

By fusing many different data flows across different sources at a customer level, the system 200 is also able to identify new attributes that can be used to infer individual customer's shopping behaviors. This discovery process can be done by identifying statistical correlations in the data attributes and customer behavior, or other machine learning techniques to associate the data points.

For example, by performing correlation analysis the system 200 may infer that the local grocery store sales are higher right before an impending storm event. The system 200 takes this into account to compute its combat zones with respect to the competitors and recommends to the retailer management at the local locations to stock up and provide relevant promotions before another impending event of similar nature on relevant product categories. The combat zone can further be used to understand the expected demand of customers and estimate optimal stocking levels of the inventory in the local store.

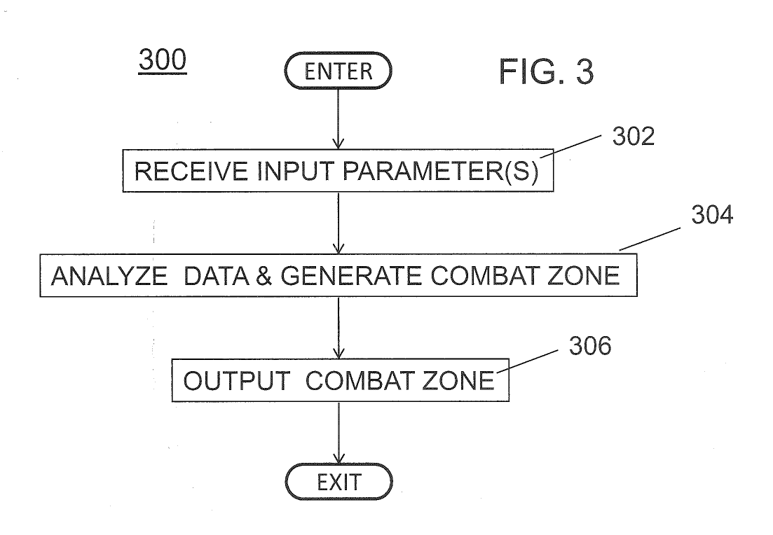

In summary and as shown exemplarily the flowchart 300 of FIG. 3, a combat zone is generated by combat zone analyzer in step 304, using a set of input parameters 302 that incorporate one or more of a customer or customer set, a time or time period, a merchant or merchant category, product set or product features, and/or service(s). In step 306, the output of the combat zone analyzer is a spatiotemporal area and time range, coupled with a probability function that can determine the likelihood of visiting the specified merchant and/or shopping for the indicated product or product set offered by the merchant. The resultant data can be formatted and presented as a display to a user.

Note that the combat zone can be time, merchant, customer, and product specific according to the input parameters. The output can be returned as a numerical probability function, as a subdivision of the original spatiotemporal area into subparts, each of which represents a range of likelihoods with the original area, as a visual representation (see the figures), or as a combination of all of the above. Thus, the output of the combat zone analyzer comprises a consumer affinity toward local competing retailers. The probability function can be a prediction of when a specific customer will visit the retail store within a specific time period, as can be statistically calculated based on previous visit information for that customer.

Returning to FIG. 1, suppose, for example, store A is a home improvement center, that customer X has been a frequent customer at store A, including making visits to store A's website, StoreA.com, and that store B is a competitor of store A for the product set of kitchen tiles. By contextual data as recently received, filtered, and associated with customer X, store A is alerted that customer X is currently located in a coffee shop on a Saturday morning that is three miles from store A and one mile from store B. Additional contextual data associated with customer X shows that customer X has been searching online for kitchen tile and related products in recent weeks and has viewed several how-to videos that suggest that customer X is planning an impending kitchen project expenditure.

The present invention also receives input data for local advertising of competitors and has detected that competitor store B has advertised a kitchen tile promotion for this weekend. Because of the customer X's current location on a Saturday morning as being closer to competitor store B, store A determines that this scenario 100 places customer X in a combat zone that requires marketing action to attempt to persuade customer X to visit store A before buying tiles for a project. Based on the above contextual data, the present invention determines that customer X is currently located in a combat zone relative to competitor store B for kitchen tile products and that a marketing event would be appropriate.

Accordingly, store A uses the present invention to immediately send both an email and SMS text to customer X, suggesting that he visit store A today to see their unmatched assortment of tile. Store A includes a personalized offer for customer X to receive 20% off all kitchen tile project purchases that he makes this weekend only.

Assume that customer X receives the marketing message and decides to head over to store A after his coffee to check on this unexpectedly timely offer. He does indeed have a big project in mind and appreciates the opportunity to stretch his home improvement dollars. Not only does customer X receive the 20% discount on his purchase at store A, but the present invention also provides a $5 gift card for his next visit to the coffee shop that was determined by the present invention to be associated with customer X's initial current location detected early on Saturday morning.

The above example is only one exemplary illustration of targeted marketing enabled by the creation of combat zones as described in the present invention. While the above example used real time tracking information of a customer, often readily available by mobile devices frequently used by many consumers, this is not necessary in all embodiments or implementations. For instance, under the similar circumstances customer X could be sent a notification of store A's sale when it is learned that store B is conducting a sale based on, for example, customer X's residence alone, regardless of any detection of current location.

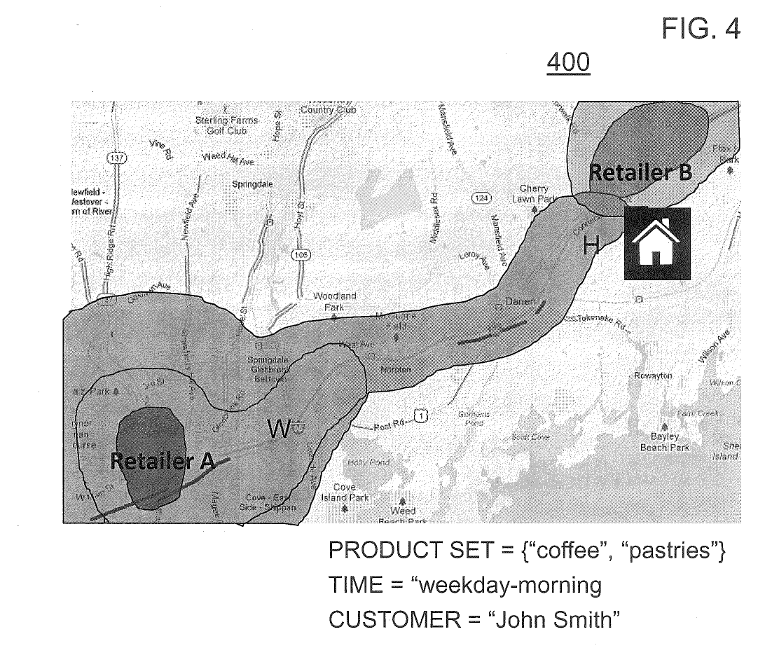

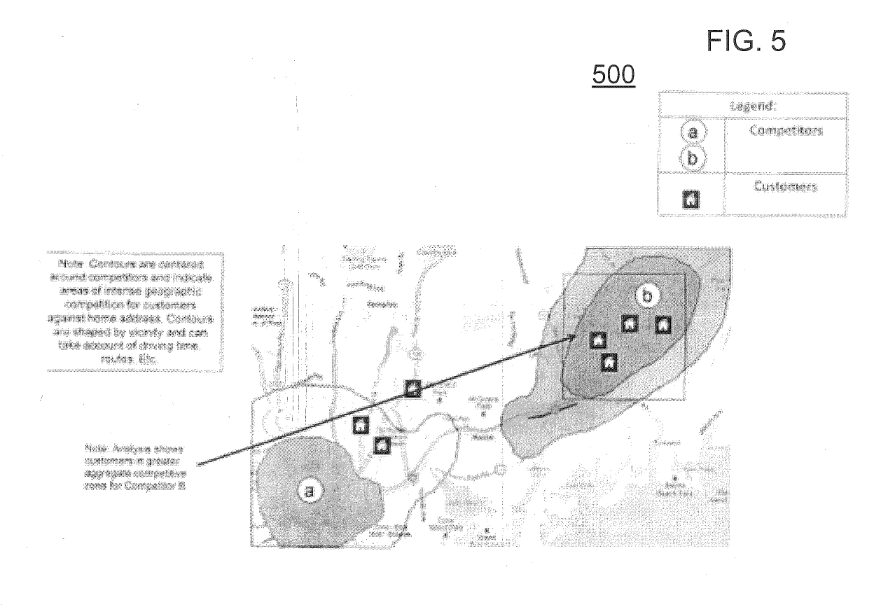

Visual representations of two exemplary types of combat zones are illustrated in FIGS. 4 and 5, respectively. FIG. 4 illustrates a combat zone 400 for an individual customer. The combat zone 400 is parameterized, either automatically or by user inputs, to determine the shopping likelihood for a specific customer, with the product set parameter set to “coffee”, and the time parameter set to “weekday-morning”. The input parameters are not specific or limited to a given merchant(s) or number of merchants, although two merchants are illustrated for descriptive purposes. The combat zone 400 processing components have incorporated contextual data about the customer, specifically that he/she has the indicated home and work locations, labeled “h” and “w”.

Thus, in the example of combat zone 400, a retailer might be engaged in a marketing strategy to augment its morning coffee shop business, and the system user has entered “coffee” and “weekday-morning” as input parameters, with the system 200 automatically monitoring activity of a number of specific customers including the specific customer shown in FIG. 4. Alternatively, the system 200 could be preset to automatically monitor a number of specific customers' activity during weekday mornings by having “coffee” and “weekday-morning” preprogrammed as input parameters during weekday traffic periods. As another option, a specific customer could also be entered as one of the input parameters.

The combat zone 400 of FIG. 4 also incorporates contextual information about roads and traffic conditions between home and work locations, as well as the insight that the customer is likely to travel between those locations in the given time interval “weekday-morning”. Note that the combat zone areas are warped along the roadway, indicating an inferred possibility that the customer might stop for coffee along the most likely route. This inference might be based, for example, on a review of previous location traces for this customer, including previous instances when the customer locations indicated that the customer was indeed detected as being at a competitor providing “coffee” on a “weekday-morning”, presumably for purpose of purchasing coffee. Additionally, the combat zone processing components incorporate knowledge of business locations that possibly demonstrate an affinity to the user's interest, or which are related to the product category. This relation can also be transitive, meaning that the combat zone processor would infer an attraction to a specific geographic area due to the presence of related businesses. The output combat zone(s) is displayed visually and has different sub-areas of likelihood that the customer would make a coffee purchase at various store locations across a given geography In the example of FIG. 4, darker shading or different colors indicate calculations of a higher likelihood of the customer visiting a specific merchant in the vicinity of the color. Note the likelihood function peaks at two cluster areas, one is a shopping area with anchor merchant A at location labeled “a” and another is a shopping area with anchor merchant B at location labeled “b”. Note that the combat zone processor has inferred an attraction to the “a” and “b” locations due to their proximity to the spatiotemporal dwell points “h” and “w”, corresponding to the customer home and work locations.

This combat zone can and almost assuredly will change over time. For example, the combat zone 400 for “coffee” for a customer during the day, when the customer is at work, would be expected to differ from the combat zone for the same customer in the afternoon, when the customer is at home, and a combat zone for “coffee” would likely also be different again during morning commutes. Additional variation in parameters or contextual information can dynamically skew the combat zone.

For example, if a different product set is chosen, such as, for example, organic groceries, such different product set might only be available in proximity to or specifically at merchant B, and the resultant combat zone could be drastically different from that shown in FIG. 4. Also, contextual data might suggest that the customer may be willing to travel farther for specific categories such as organic items. These factors would result in a dramatically different output combat zone. Additionally, if weather factors change, or new home delivery services are offered by a retailer, roadway conditions or the propensity for driving distance of the user might change, again dramatically affecting the combat zone.

FIG. 5 illustrates another exemplary type of combat zone 500 in which the customer is not specified, but the merchant category is specified as “multi-line-retailer”. Thus, the combat zone 500 is merchant-centric. This type of combat zone computation may be used by a multi-line retailer that has a set of recognized competitors. The recognized competitors may be product or product category specific.

As with FIG. 4, for combat zone 500 of FIG. 5, the combat zone analyzer has also taken into account customer home and work locations, as well as contextual information about the roadways and weather conditions. The combat zone analyzer has taken into account a corpus of customers, as well as aggregate demographic information about customer populations in comparison to the product offerings of the known competitors.

This aggregate demographic information allows the combat zone analyzer to output the illustrated combat zone areas as well as correlate that to possibly different customer sets. In this case, it has determined that the aggregate customer affinity is higher for competitor merchant B than merchant A, as merchant B is located inside a population of customers in higher probability areas of its combat zone. This information can be further channeled to merchandising or operations modules that operate with this analytical information as input, to possibly make a recommendation for possible marketing actions.

While many of the above examples refer primarily to individual customers or merchants, the combat zone 500 shown exemplarily in FIG. 5 demonstrates how combat zones can also be created for groups of customers or demographics. These combat zones may also be rendered to a dashboard so that a retailer can analyze customer ranges/trends.

The combat zone processor of the present invention is also designed to that it can incorporate methods to learn from its actions and the customer responses to those actions. Thus, over time, the system 200 can track which advertisements, marketing stimuli, merchandising strategies or pricing strategies to which a particular customer or customer segment has responded. By so doing, the retailer and automated system can use this information to tailor future strategies. Such feedback data can also be used for general demographics as well, which can allow the tailoring of strategies to a demographic group.

In another exemplary aspect, the combat zones for a given store or group of stores is computed and compared against a test population of customer locations dispersed across the combat zone area, with an aggregate score being computed by summing the resultant likelihoods across all customers in the test population. The aggregate score can then be used as an efficacy measure of the store, product, or other contextual assumption used as an input parameter. Further, the efficacy measure can be inspected across a test set of marketing or promotional conditions to determine an optimal set of marketing or promotional conditions to use in future marketing, merchandising, or pricing campaigns.

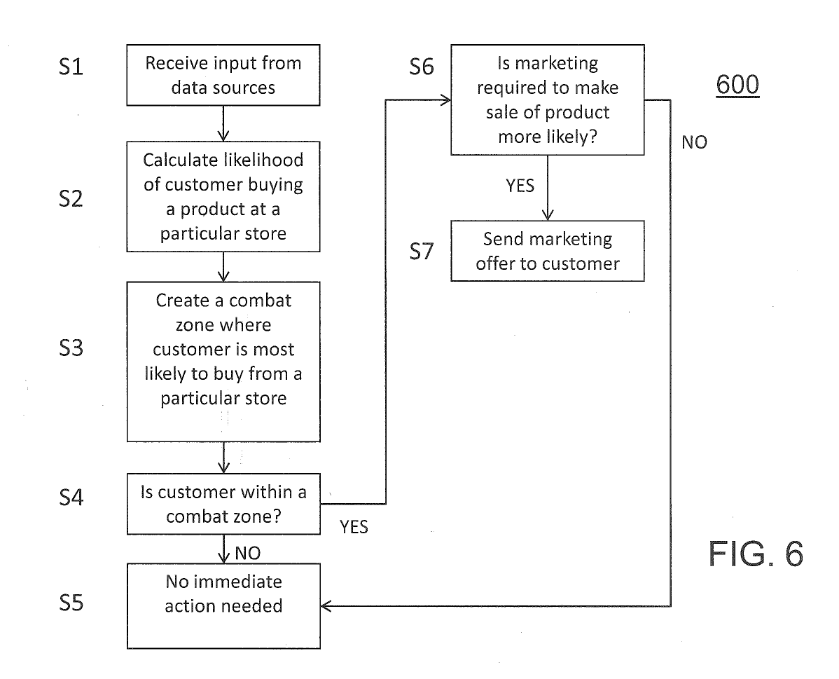

FIG. 6 illustrates a simplified exemplary method 600 of creating and using a combat zone based on customer location, according to an exemplary embodiment of the invention. In this non-limiting example of the process, input is received from data sources (S1). The likelihood of a customer buying a product at a particular store at a particular time is then calculated (S2). These likelihoods, calculated in a spatial and temporal relationship, are intended to indicate where a customer is most likely to buy from a store, to thereby produce combat zones (S3). As pointed out previously, the probability function can be based upon previous visit history for that customer.

If a customer's current location is detected, then the customer's location can be entered as data into the analyzer. It is then determined if the customer is located within a particular combat zone (S4). If not, then further immediate actions may not be required (S5). If located within a particular combat zone for a specific product or product set, it is then determined if a marketing action might make the sale more likely. This determination could be based on a percentage or a weighting between stores, or any other appropriate method (S6). If marketing is determined as desirable, then, in step S5, a marketing offer is requested to be sent to the customer in step S7. If not, then no further action is immediately required (S5).

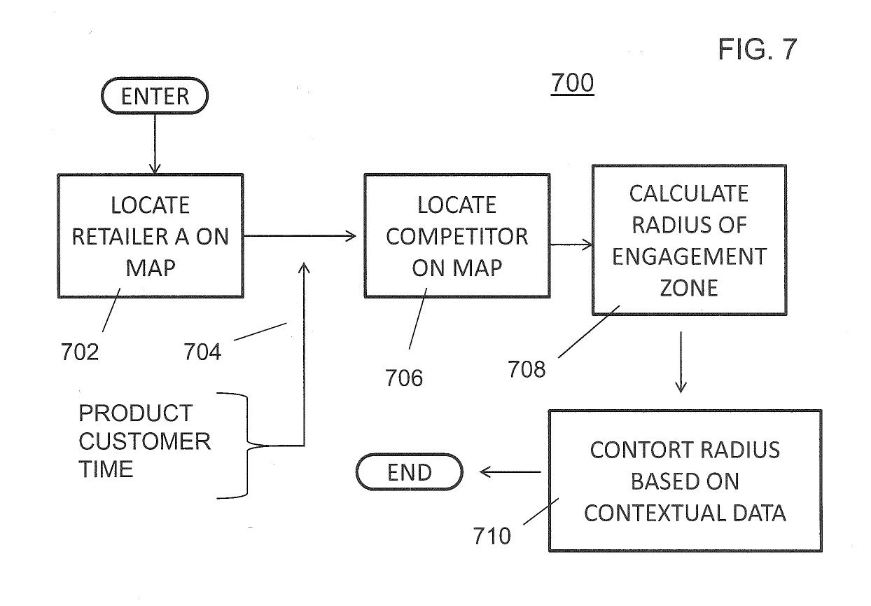

FIG. 7 provides a flowchart 700 of an exemplary technique of modeling a combat zone. The concept of the present invention of modeling customer engagement zones shown exemplarily in FIGS. 4 and 5 is based upon a local map of each retail store for a retail entity and can be directed toward specific customers and specific products or service(s) and specific time periods.

For example, if Retailer A in FIG. 1 is the retail entity that is developing engagement zones for its store located at location a, then the first step 702 in the development of the engagement zones is to retrieve map data for this store location a, and to locate the store location precisely, for example, using an address. Such map information is readily available through a number of well known websites such as mapquest or google map, which map data includes also information about roads, landforms, etc. The address of the store of interest is exemplarily available through the location data in the master data management (MDM) database of the retail entity or could alternatively be obtained through any number of on-line, publically-available data sources such as a telephone or business database.

In step 704, a specific product or product set or service(s) available from inventory of the retail entity is retrieved, either as an automatic processing or as based upon user input parameter(s), along with possibly a specific customer or customer set and a specific time period of interest. Such product identification information is readily available from the MDM inventory database. In step 706, given a specific product Y or product set Y′, the local competitor to Retailer A is identified, using any number of possible business databases. Such retailer information, including the different products offered by different retailers, is available from various databases including different data sources via the Internet.

The location of the competitor is then located on the map data, in step 706. In FIG. 4, the competitor is assumed to be Retailer B at location b, and only one competitor is used for this explanation of this aspect of the present invention. But it should be clear that any number of other competitors in the vicinity of Retailer A could likewise be added to the map data.

At this point, an initial engagement zone radius for product Y can now be calculated in step 708 for Retailer A at its store location a based, for example, on an estimation of how much of product Y is sold by Retailer A at store location a versus the amount estimated to be sold by Retailer B at location b. Calculation of the engagement zones can thus be a straightforward calculation of radii around each competing retailer based on their ratio of this specific product, which is referred to herein as the “affinity” for customers to purchase this product from each retailer.

More specifically, on one exemplary embodiment, boundaries of the engagement zones can be considered as radii of circles of an area separating two localized competing retailers who sell a specific product Y or products that directly compete with product Y, but with the radius based upon the relative amount of purchases for product Y and as distorted by a convenience factor, such as a factor reflecting the convenience for a customer to travel to the retailer site. Additional alternative distortions of the radii could also be based on other geographical (e.g., landforms such as mountains, water, etc., or political divisions such as zip code boundaries, or drive times given road configurations and conditions).

Thus, for example, in FIG. 4, Retailer A is assumed to make many more sales overall of product Y than does Retailer B, and there is a single main traffic channel interconnecting these two retailers. Accordingly, the radius around Retailer A and the radius around Retailer B, as between these two competitors is larger for Retailer A than for Retailer B. As clearly seen in FIG. 4, the radius of the engagement zones is distorted to follow the single traffic channel, as executed in step 710 and as can be seen particularly for the engagement zone for Retailer A. Some of the distortion can be due to convenience of the customer to travel to Retailer A, including, for example, transportation routes and dynamic changes in road, traffic, or weather conditions. This embodiment of defining boundaries of retailer engagement zones based on traffic routes such as roadways or mass transit routes is actually an offshoot of previous tooling mechanisms developed by various of the present inventors as directed to traffic management optimization, whereby dynamic traffic routing can be determined based on estimated travel time to a desired destination as based on traffic information updates.

A more complex exemplary calculation of an engagement zone can be directed to specific customers, such as demonstrated in FIG. 4 in which the retailer engagement zones are calculated for specific customer X (e.g., John Smith). In this version of calculating engagement zones, the specific customer X has a purchase history with Retailer A for product Y, as would be easily determined from the purchase history database of the retail entity having a store at location a. Such purchase history can be normalized relative to other customers in a similar category, to derive a affinity of the customer to different local competing retailers, as described below.

The present invention, as well as co-pending application entitled “FORECASTING FOR RETAIL CUSTOMERS”, the contents of which are hereby incorporated herein by reference, teaches to develop a profile of information, referred to herein as “contextual data”, relative to Customer X that might be useful for modeling purchasing by this customer at Retail A's store located at a. In the context of the present invention, this additional information for Customer X might include such information as the home h and work w addresses for Customer X, as well as typical routing taken by Customer X for commuting to and from work based on roadways interconnecting the home and work locations, as determined, for example, by consulting a history of the location traces for Customer X over a period of time. Additional contextual data might include dynamic updates of current traffic that might influence Customer X's commute routing.

In contrast to the calculation of the relative radii of the engagement zones described previously, wherein relative overall sales of Product Y between Retailer A and Retailer B, in the case of engagement zones for individual customers, the radii for these two competing stores is based upon the amount of purchases for Product Y that Customer X is known to make at Retailer A relative to the amount that can be inferred to be made from Retailer B. If the amount from Retailer B is not available to Retailer A, then system 200 can infer or estimate this relative amount by, for example, placing Customer X into one of various possible categories of consumers that shop at Retailer A and calculate how much of Product Y that Customer X's purchase record at Retailer A indicates was purchased from Retailer A versus the maximum amount of Product Y that was purchased by any individual in the same category of consumers at Retailer A.

For example, if Customer X is ascertained from contextual data to be, for example, a consumer who is a spouse in a family with two children ages 5 and 8, then this consumer category of a married couple with two children of similar ages can be used to determine the typical amount of purchase of Product Y for this consumer category.

To make this determination, Retailer A might assume that a consumer in this same consumer category who has made the largest amount of purchases of Product Y from Retailer A over a specific time interval represents a consumer of this same category that purchases Product Y only from Retailer A. This maximum purchaser thereby is assumed to demonstrate a consumer that has maximum affinity to Retailer A for Product Y. Therefore, by normalizing each of Retailer A's customers' purchases for Product Y relative to the maximum purchases for this consumer category for the same time period, each Customer X in this same consumer category can have assigned an affinity for Retailer A for Product Y. Other statistical or analytical methods can also be used to calculate specific affinity values since the present invention merely needs any mechanism that provides a quantitative value for each product/product set/service that indicates relative amounts for which Customer X visits/purchases from Store A.

Retailer A can then infer that Customer X uses competitor Retailer B for the remaining purchases of Product Y that would be expected to be purchased by a consumer in this same customer category. Retailer A can also then use this affinity value for each Customer X to calculate an engagement zone for each Customer X for each Product Y in a similar manner, as a radius based on the customer's calculated affinity value and as modified by, for example, relative convenience such as estimated travel time along established routing to Retailer A or Retailer B.

As further shown in FIG. 4, additional areas of the engagement zone can be further calculated, as demonstrated by the darker region closer to Retailer A's location a. This darker region represents an even higher probability that Customer X would purchase Product Y from Retailer A. Such differences in probability could be based simply on distance or other measures of convenience or could include an aspect of previous actions of Customer X as determined on the stored location trace history of Customer X at different locations.

Engagement Zones as Calculated on Location Trace History

Another possible exemplary mechanism for calculating an engagement zone around a retail store is based upon merely tracking over time the location reports for each customer of interest, noting particularly those locations that indicate the locations of competitors for different products. As noted previously, databases exist for purpose of researching which products different retail stores offer. Such location tracking over time would permit the system 200 to infer and learn which competitor is being used by each customer for each product also available at the retail store itself. Additionally, customer trace history over time permits a possible mechanism by which a probability function can be calculated for the likelihood that a specific customer would visit the different retail stored at any specific time when detected at any specific location. Thus, engagement zones can be spatiotemporal views of specific customers and can additionally include a dimension of a specific product or product mix.

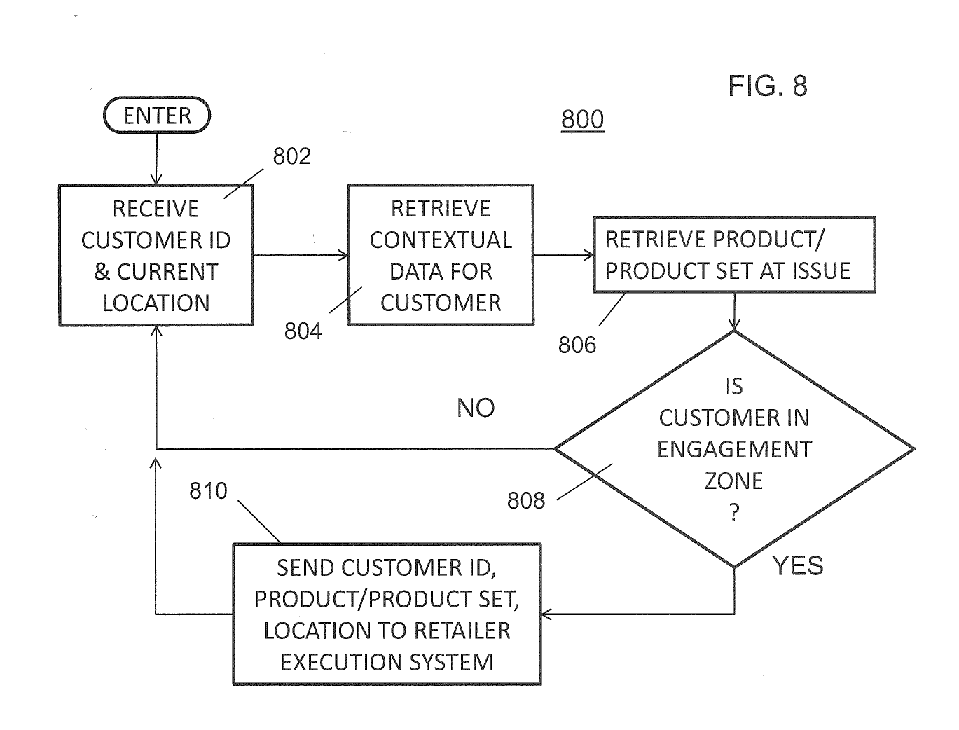

FIG. 8 shows an exemplary flowchart 800 of processing in the recommendation engine 226 for an exemplary embodiment of the present invention. This mechanism 800 is based upon the engagement zones as calculated in FIG. 7 and also relies upon contextual data, for example, current location of a specific Customer X. In step 802 the recommendation engine 226 has received, via the analytics engine 222 (see FIG. 2) and as contextual data relative to Customer X, an indication of Customer X's current location. In step 804, the recommendation engine 226 retrieves contextual data for Customer X, searching particularly Customer X's contextual data for any product Y that might be of current interest for Customer X.

For example, as possibly shown in FIG. 4, Retailer A might have developed an engagement zone for the “coffee/pastries” product set for Customer X, as demonstrated in this figure and would like to attempt to entice Customer X from purchasing coffee and/or pastries from competitor Retailer B whenever possible, where competitor Retailer B might be, for example, a neighborhood McDonalds located near Customer X's home. If, in step 802 of FIG. 8, the recommendation engine has received a current location of Customer X (that happens to be within the engagement zone for McDonalds, Retailer B), the recommendation engine would initially retrieve all available product sets and associated engagement zones and detect in step 806 that product set “coffee/pastries” for Customer X provides an engagement zone that is currently active for Customer X, in step 808. Therefore, the recommendation engine sends the identification of Customer X in step 810, along with the product set “coffee/pastries” and possibly Customer X's current location, to Retailer Execution Systems 230.

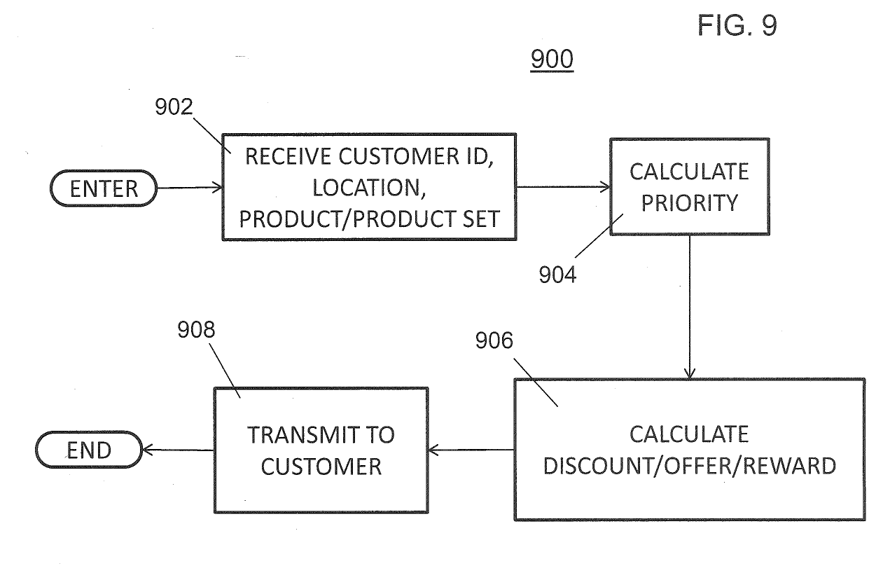

FIG. 9 illustrates an exemplary flowchart 900 of the Retailer Execution Systems 230. In step 902, the Retailer Executions Systems 230 receives one or more of a customer id, product, and location from the Recommendation Engine 226. In step 904, the Retailer Execution Systems 230 calculates a priority for to the customer identification, product, and location, where the priority indicates whether this combination possibly warrants transmitting a discount offer or reward or other marketing strategy to Customer X, and in step 906, based on the priority level, an amount of discount or reward is calculated. In step 908, the Retailer Execution Systems retrieves possible communication mechanisms available for contacting Customer X and determines which communication mechanism would be optimal for communicating with Customer X at that current location and transmits such discount offer/reward accordingly.

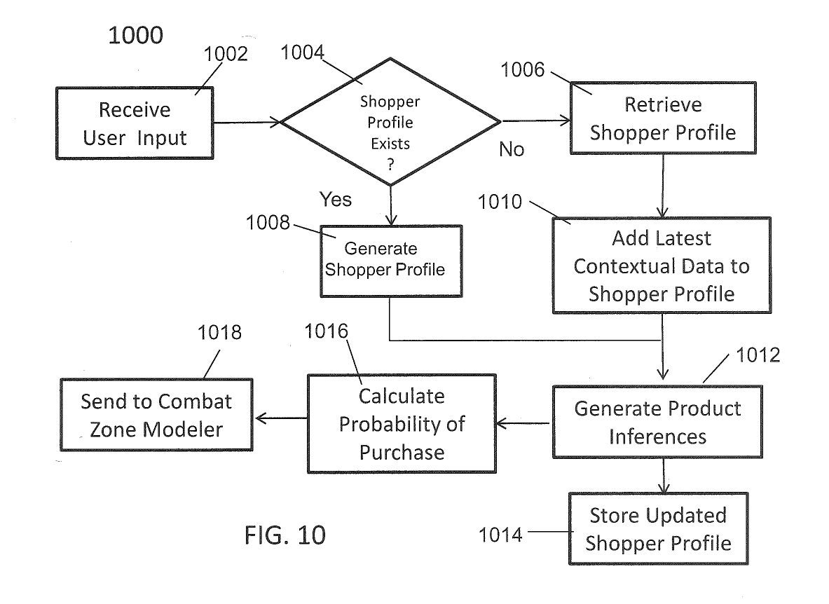

FIG. 10 shows an exemplary flowchart 1000 demonstrating how system 200 receives and uses contextual data to develop profiles for individual shoppers or shopper groups for use in determining the combat zones of the present invention. In step 1002, user input provides an individual or group of shoppers for determination of engagement zones. In step 1004, it is determined whether a shopper profile has already been developed for this input parameter, and, if so, such profile is retrieved in step 1006. If no profile can be found, then one is generated in step 1008. As mentioned, such profiles are generated by filtering contextual data inputs based on identification tags corresponding to individuals in the retailer database as known customers and then appropriately associating such data respectively with those individuals.

Additional profile information can be added, based on inferences that can be gleaned from contextual data. For example, a customer's residence and work address can be the basis of an inference about commuting routes taken by the customer, as might then be confirmed by a history of location traces of that customer. Other examples of inferences might be the likely school that the customer's children are likely to attend or determination that the customer is a follower of any specific sports events. Another example of an inference generation would be the mechanism of using machine learning algorithms to correlate different product combinations from the purchase history of the customer.

In step 1010, the latest contextual data is added to the shopper profile, including any updates to the profile that the latest contextual data input might suggest. As mentioned, contextual data 412 is input from any number of sources. In step 1012, inferences are generated for different products that are in the store inventory, or specific products can be provided as an input parameter by a user, and, in step 1014, the updated profile can be stored in memory for future use. In step 1016, a probability of the customer purchasing a product from the retailer and/or a probability of visiting the retailer store within a specific time window is then calculated, and this information is provided as input to the combat zone modeler in step 1018.

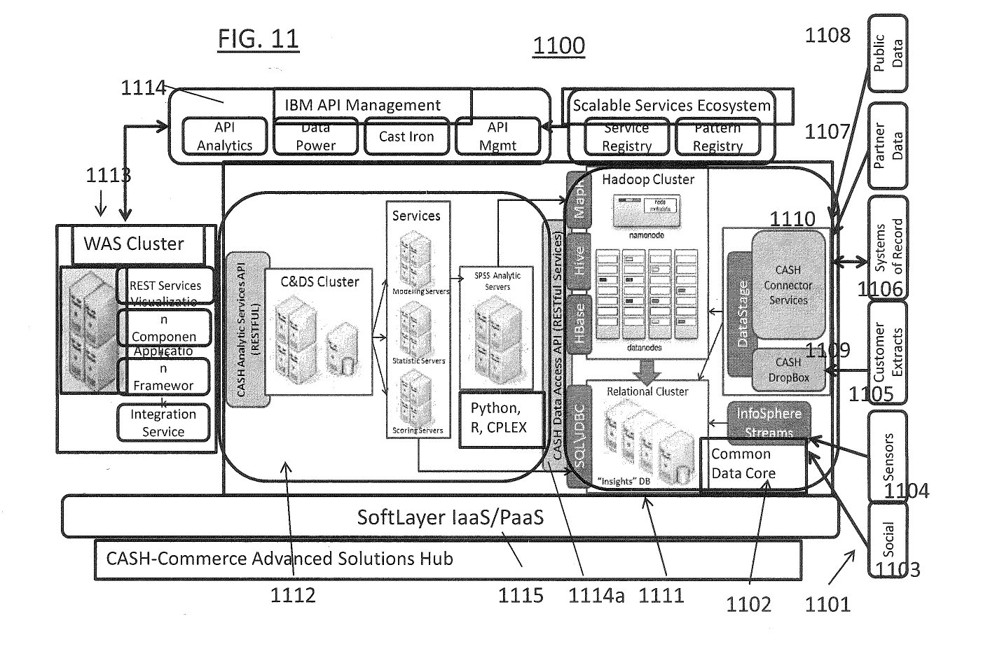

FIG. 11 shows an exemplary embodiment of the architecture 1100 of computing resources that can be used to implement the analytics pipeline in the present invention. Inputs 1101, shown on the right side of the figure, provide data that is collected in a data input stage 1102. As exemplary examples discussed previously, the input data could come from social media 1103, such as Twitter, Facebook and local news media, or sensors 1104, such as positional or biometric sensors, received as streaming data. Addition data arrives as customer extracts 1105, such as customer profile data, loyalty card data, and coupon redemption history and which is received by a software product like IBM Dropbox 1109. Systems of records 1106, such as retailer purchase history, point of sale transaction data and available inventory records, partner data 1107, such as customer data and survey data depending upon retailer's partnerships with other businesses, and public data 1108, such as publically available RSS feeds, are received by connector services 1110 which pull data from different input services. The connector services contain a range of components to be able to pull or accept data from different data sources.

Hadoop cluster 1111 is a cluster of community hardware used for large scale storage and processing of data sets, both as structured and/or unstructured data. Additionally traditional relational database tools such as IBM DB2 are also used to store structured data. The analytics engine 1112 exemplarily comprises clusters of servers used to filter and analyze the input data and includes data processing and predictive modeling software such as IBM SPSS Modeler, deployment platforms such as IBM SPSS Collaboration and Deployment Services, and optimization software such as CPLEX for various types of mathematical optimizations, including very large integer programming problems.

IBM Websphere Application Server (IBM WAS) cluster 1113 provides the middleware to support a range of web services. The API Management modules 1114 provide control management functions for the analytic engine 1112 as well as user interface, so that a user can interface with the system 1100 to generate forecasts for different customers and monitor customer purchases relative to the forecasts.

SoftLayer Infrastructure as a Service (IaaS)/Platform as a Service (PaaS) 1115 is an IBM product that provides an interface for cloud services.

The present invention may be a system, a method, and/or a computer program product. The computer program product may include a non-transitory, computer readable storage medium (or media) having computer readable program instructions tangibly embodied thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although the following description includes a detailed description on cloud computing, implementation of the teachings recited herein are not limited to a cloud computing environment. Rather, embodiments of the present invention are capable of being implemented in conjunction with any other type of computing environment now known or later developed.

Turning now the possible hardware implementations that would support the methods of the present invention, it is previously noted that the invention could be supported with most computer architectures, including a cloud-based architecture. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

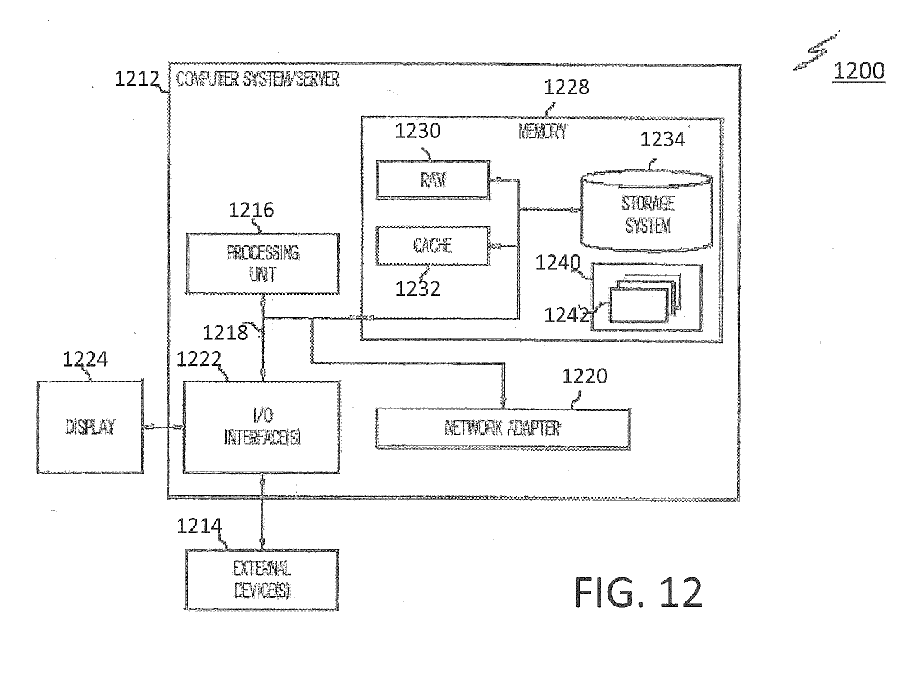

Referring now to FIG. 12, a schematic of an example of a cloud computing node 1200 is shown. Cloud computing node 1200 is only one example of a suitable cloud computing node and is not intended to suggest any limitation as to the scope of use or functionality of embodiments of the invention described herein. Regardless, cloud computing node 1200 is capable of being implemented and/or performing any of the functionality set forth hereinabove.

In cloud computing node 1200 there is a computer system/server 1212, which is operational with numerous other general purpose or special purpose computing system environments or configurations. Examples of well-known computing systems, environments, and/or configurations that may be suitable for use with computer system/server 1212 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1212 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1212 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 12, computer system/server 1212 in cloud computing node 1200 is shown in the form of a general-purpose computing device. The components of computer system/server 1212 may include, but are not limited to, one or more processors or processing units 1216, a system memory 1228, and a bus 1218 that couples various system components including system memory 1228 to processor 1216.

Bus 1218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1212 typically includes a variety of computer system readable media. Such media may be any available media that is accessible by computer system/server 1212, and it includes both volatile and non-volatile media, removable and non-removable media.

System memory 1228 can include computer system readable media in the form of volatile memory, such as random access memory (RAM) 1230 and/or cache memory 1232. Computer system/server 1212 may further include other removable/non-removable, volatile/non-volatile computer system storage media. By way of example only, storage system 1234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1218 by one or more data media interfaces. As will be further depicted and described below, memory 1228 may include at least one program product having a set (e.g., at least one) of program modules that are configured to carry out the functions of embodiments of the invention.

Program/utility 1240, having a set (at least one) of program modules 1242, may be stored in memory 1228 by way of example, and not limitation, as well as an operating system, one or more application programs, other program modules, and program data. Each of the operating system, one or more application programs, other program modules, and program data or some combination thereof, may include an implementation of a networking environment. Program modules 1242 generally carry out the functions and/or methodologies of embodiments of the invention as described herein.

Computer system/server 1212 may also communicate with one or more external devices 1214 such as a keyboard, a pointing device, a display 1224, etc.; one or more devices that enable a user to interact with computer system/server 1212; and/or any devices (e.g., network card, modem, etc.) that enable computer system/server 1212 to communicate with one or more other computing devices. Such communication can occur via Input/Output (I/O) interfaces 1222. Still yet, computer system/server 1212 can communicate with one or more networks such as a local area network (LAN), a general wide area network (WAN), and/or a public network (e.g., the Internet) via network adapter 1220. As depicted, network adapter 1220 communicates with the other components of computer system/server 1212 via bus 1218. It should be understood that although not shown, other hardware and/or software components could be used in conjunction with computer system/server 1212. Examples, include, but are not limited to: microcode, device drivers, redundant processing units, external disk drive arrays, RAID systems, tape drives, and data archival storage systems, etc.

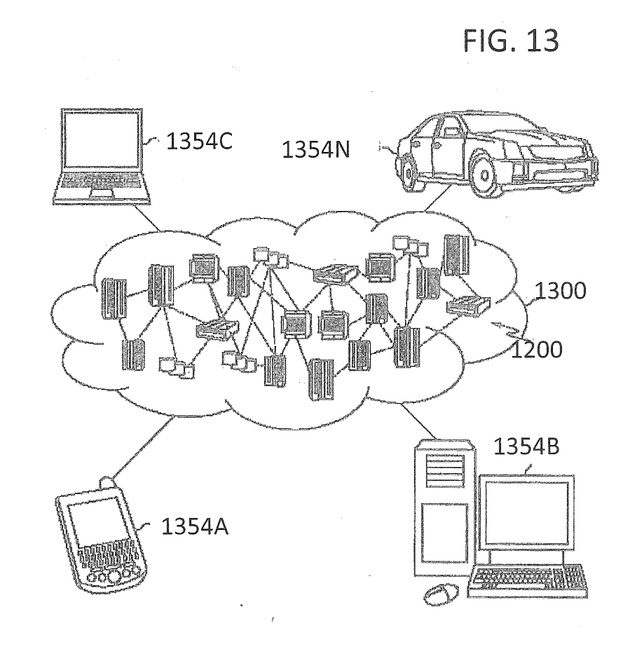

Referring now to FIG. 13, illustrative cloud computing environment 1300 is depicted. As shown, cloud computing environment 1300 comprises one or more cloud computing nodes 1200 with which local computing devices used by cloud consumers, such as, for example, personal digital assistant (PDA) or cellular telephone 1354A, desktop computer 1354B, laptop computer 1354C, and/or automobile computer system 1354N may communicate. Nodes 1200 may communicate with one another. They may be grouped (not shown) physically or virtually, in one or more networks, such as Private, Community, Public, or Hybrid clouds as described hereinabove, or a combination thereof. This allows cloud computing environment 1300 to offer infrastructure, platforms and/or software as services for which a cloud consumer does not need to maintain resources on a local computing device. It is understood that the types of computing devices 1354A-N shown in FIG. 13 are intended to be illustrative only and that computing nodes 1200 and cloud computing environment 1300 can communicate with any type of computerized device over any type of network and/or network addressable connection (e.g., using a web browser).

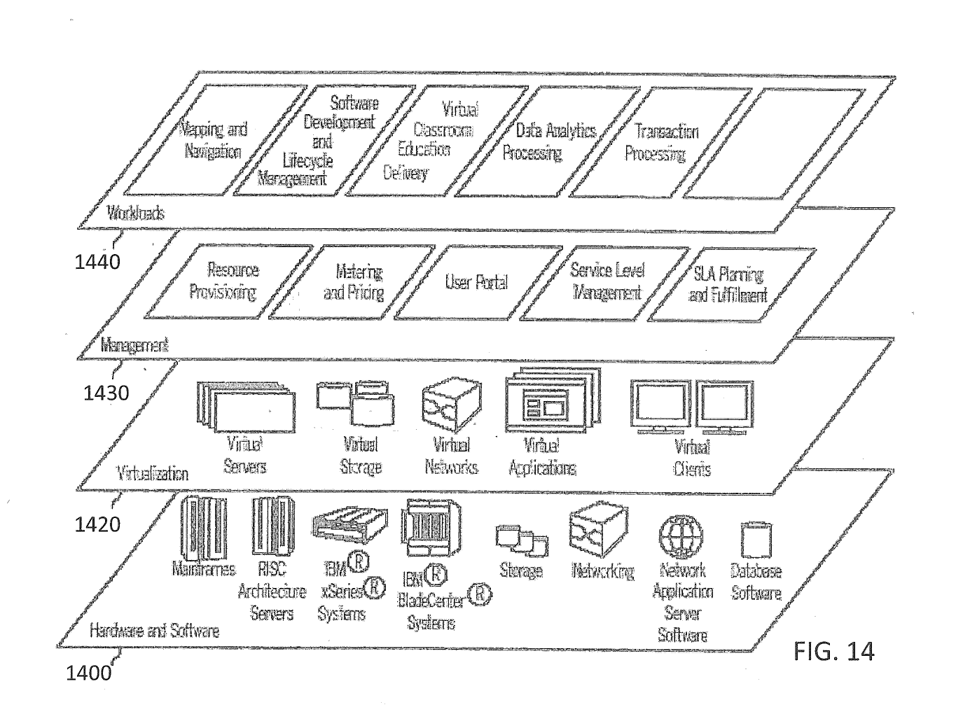

Referring now to FIG. 14, a set of functional abstraction layers provided by cloud computing environment 1300 (FIG. 13) is shown. It should be understood in advance that the components, layers, and functions shown in FIG. 14 are intended to be illustrative only and embodiments of the invention are not limited thereto. As depicted, the following layers and corresponding functions are provided:

Hardware and software layer 1400 includes hardware and software components.

Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1420 provides an abstraction layer from which the following examples of virtual entities may be provided: virtual servers; virtual storage; virtual networks, including virtual private networks; virtual applications and operating systems; and virtual clients.

In one example, management layer 1440 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1460 provides examples of functionality for which the cloud computing environment may be utilized to implement the present invention. Examples of workloads and functions which may be provided from this layer include the implementation of the analytics engine 222, the customer combat zone modeler module 224, the recommendation engine module 226, and even possibly the retailer execution system module 230, as exemplarily shown in FIG. 2.

While the invention has been described in terms of exemplary embodiments, those skilled in the art will recognize that the invention can be practiced with modification within the spirit and scope of the appended claims.

Further, it is noted that Applicants' intent is to encompass equivalents of all claim elements, even if amended later during prosecution.

Having thus described our invention, what we claim as new and desire to secure by Letters Patent is as follows:

1. A method comprising:
receiving, as input data in a processor of a computer, an identification and a location of a retail entity;
retrieving map data relevant for said retail entity and locating said retail entity on said map data;
receiving, as input data, data identifying at least one of a product, a product set, and a service or services;
retrieving a listing of one or more competitors that offer said product or one or more products of said product set or said service(s) as a competitor of said retail entity for said product, product set or service(s) and locating said one or more competitors on said map data; and
calculating an affinity for consumers for said product, product set, or service(s) for said retail entity and each of said one or more competitors.

2. The method of claim 1, wherein said affinity comprises a calculation of one of:
a probability that a consumer will purchase said product or said service(s) or a product of said product set from said retail entity or from a competitor; and
a probability that a consumer will visit said retail entity within a preset time period.

3. The method of claim 1, further comprising:
receiving an identification of a specific consumer;
generating at least one engagement zone for said specific consumer and said product, product set, or service(s) for said retail entity and said one or more competitors, said engagement zone comprising an area determined to warrant a marketing action directed to said specific consumer to attempt to persuade said specific consumer to visit said retail entity to possibly purchase an item at said retail entity rather than from a competitor;
receiving input data indicative of a location of said specific consumer; and
determining whether said specific consumer's location is within an engagement zone.

4. The method of claim 3, further comprising;
if a marketing action is determined as appropriate, generating a marketing message in a context of said product/product set/service(s) and of said contextual data;
retrieving from a memory a transmission method to be used for transmitting a marketing action directed to said specific consumer; and
transmitting said marketing action to said specific consumer using said transmission method.

5. The method of claim 4, further comprising;
monitoring whether said specific customer responds to said marketing action within a preset time period; and
storing information indicative of said specific customer's response to said marketing action.

6. The method of claim 1, wherein said affinity comprises a calculation of a radius between said retail entity and each said competitor indicative of relative amounts of said product or product set or service(s) purchased at said retail entity and each said competitor;
wherein said radius is distorted based on one or more of:
features of said map data,
a measure of convenience to travel to said retail entity or each competitor, and
contextual data, said contextual data comprising data indicative of events or conditions that possibly would influence retail sales at said retail entity.

7. The method of claim 6, wherein said contextual data comprises one or more of:
data reflecting temporal conditions or events;
data related to potential shoppers; and
data related specifically to said each competitor.

8. The method of claim 6, further comprising:
calculating a probability function that a specific customer will visit said retail entity; and
providing output data for displaying said probability function on a map display based on said map data.

9. The method of claim 1, wherein said calculating said affinity comprises:
retrieving data from a history of location traces of a specific customer to determine travel paths of said specific customer;
superimposing said travel paths on said map data;
using a history of previous visits of said specific customer to said retail entity to determine a likelihood that said specific customer will visit said retail entity within a specified time period based upon detecting a current location of said specific customer; and
providing output data for displaying said likelihood on a map display based on said map data.

10. The method of claim 9, further comprising:
receiving updated contextual data associated with said specific customer, said contextual data comprising data indicative of events or conditions that possibly would influence a decision by said specific customer to purchase at said retail entity.

11. The method of claim 10, wherein said updated contextual data associated with said specific customer comprises a current location of said specific customer, said method further comprising:
determining whether said current location is within an engagement zone that warrants a marketing action directed to said specific customer;
if a marketing action is determined to be appropriate, generating a marketing action in view of said updated contextual data;
retrieving from a memory a transmission method to transmit said marketing action to said specific customer at said current location;
monitoring whether said specific customer responds to said marketing action; and
storing a response of said specific customer to said marketing action.

12. The method of claim 1, as embodied in a set of computer-readable instructions tangibly embodied in a non-transitive storage medium.

13. The method of claim 1, wherein said affinity is calculated for a specific consumer.

14. The method of claim 1, wherein said affinity is calculated as directed to:
a specific consumer or consumer group;
a specific product or product set or service(s);
a specific location of said consumer or consumer group; and
a specific time or time interval.

15. A method, comprising:
receiving, as input data into a processor, an identification of a customer;
retrieving map data for a retail entity in a location of said customer and locating said retail entity on said map data;
retrieving a history of previous location traces for said customer, said location traces including an indication of a date and a time;
determining at least one recurring travel route of said customer, based on said location traces; and
superimposing said at least one recurring travel route of said customer on said map data.

16. The method of claim 15, further comprising:
receiving, as an input parameter, an identification of one of a product, a product set, and a service or services;
retrieving data for one or more competitors for said identified product, product set, or service or services; and
superimposing said one or more competitors on said map data.

17. The method of claim 16, further comprising:
receiving data indicating a current location of said customer; and
determining whether said current location warrants a marketing action to be directed to said customer.

18. The method of claim 17, further comprising:
if a marketing event is determined as appropriate, generating said marketing event;
retrieving from a memory a transmission method to be used for transmitting a marketing action directed to said specific customer at said current location; and
transmitting said marketing action to said specific consumer using said transmission method.

19. The method of claim 18, further comprising;
monitoring whether said specific customer responds to said marketing action within a preset time period; and
storing information indicative of said specific customer's response to said marketing action.

20. A system, comprising:
at least one database storing information for a retail entity, including information on customers, products, product sets, and service(s) offered by said retail entity, information on competitors, and contextual information relating to a store location and customers making purchases at said store location, said contextual information comprising at least one of:
information reflecting conditions or events that influence retail purchases at said store location; and
information of a personal nature associated with said customers making purchases at said store location and that provides a profile of personal aspects that influence retail purchases at the store location;
at least one input section to receive data from multiple data sources providing said contextual information; and
at least one processor configured to:
filter said data from said multiple data sources and associate it with said store location or said customers;
store said associated data in said at least one database;
retrieve data from said database;
analyze said retrieved data; and
generate and transmit a marketing action to a customer determined to be in an engagement zone with one of said competitors.
